(19) United States
(12) Patent Application Publication
(10) Pub. No.: US 2018/0020075 A1
(43) Pub. Date: Jan. 18, 2018

(54) APPARATUS AND METHOD FOR PROVIDING DATA BASED ON CLOUD SERVICE

(71) Applicant: SAMSUNG SDS CO., LTD., Seoul (KR)

(72) Inventor: Ted JUNG, Seoul (KR)

(73) Assignee: SAMSUNG SDS CO., LTD., Seoul (KR)

(21) Appl. No.: 15/649,862

(22) Filed: Jul. 14, 2017

(30) Foreign Application Priority Data
Jul. 14, 2016 (KR) 10-2016-0089140

(51) Int. Cl. H04L 29/08; G06F 3/06

(52) U.S. Cl. CPC H04L 67/306; H04L 67/30; G06F 3/0685; G06F 3/067; H04L 67/10

(57) ABSTRACT

An apparatus and method for providing data are provided. The apparatus for providing data according to an embodiment of the present disclosure is an apparatus for providing data based on cloud services, and includes a profile processor configured to, in response to an attribute of data, which is generated from a target object, being changed, update a data profile that was previously stored; a data collector configured to collect the data generated from the target object in accordance with the updated data profile; a data processor configured to index the collected data; and a data provider configured to provide the indexed data to a client.

### CROSS-REFERENCE TO RELATED APPLICATION

This application claims priority to and the benefit of Korean Patent Application No. 10-2016-0089140, filed on Jul. 14, 2016, the disclosure of which is incorporated herein by reference in its entirety.

### BACKGROUND

### 1. Field

The present disclosure relates to techniques for providing data based on cloud services.

### 2. Discussion of Related Art

Recently, as services provided to users have become more complicated and diverse, there has been an increasing demand for efficiently collecting and retrieving a large amount of data generated in a process of providing the services.

However, the conventional data collection and retrieval technology has been required to continuously collect and retrieve data in accordance with initially set data collection and retrieval conditions, and there have been difficulties in dynamically reflecting, even though an attribute of the data is changed in accordance with customer's requests or actual situations, the changed attribute. In addition, according to the conventional data collection and retrieval technology, in order to change the initially set data collection and retrieval conditions, it is troublesome to redevelop the entire system or process for data collection and retrieval.

### SUMMARY

The present disclosure is directed to an apparatus and method for providing data based on cloud services, which may dynamically reflect, when an attribute of data is changed, the changed attribute in a process of collecting and retrieving the data.

According to an aspect of the present disclosure, there is provided an apparatus for providing data based on cloud services, the apparatus comprising: a profile processor configured to, in response to an attribute of data, which is generated from a target object, being changed, update a data profile that was previously stored; a data collector configured to collect the data generated from the target object in accordance with the updated data profile; a data processor configured to index the collected data; and a data provider configured to provide the indexed data to a client.

Here, the profile processor may be further configured to detect the changed attribute or a time at which the attribute is changed, and update the previously stored data profile in accordance with the changed attribute or the time at which the attribute is changed.

Also, the profile processor may be further configured to update the previously stored data profile in response to connection information about a connection to the target object being changed.

Also, the connection information may include authentication information for the connection to the target object or location information of the data in the target object.

Also, the profile processor may be further configured to detect the changed connection information or a time at which the connection information is changed, and update the previously stored data profile in accordance with the changed connection information or the time at which the connection information is changed.

Also, the data collector may be further configured to connect to the target object using the connection information included in the updated data profile, and collect data corresponding to the attribute included in the updated data profile.

Also, the profile processor may be further configured to manage an update history of the data profile using the attribute or a time at which the connection information is changed.

Also, the data processor may be further configured to newly index the collected data whenever the data profile is updated, and manage an indexing history of the data.

Also, the data provider may be further configured to receive period information of data to be provided from the client, and retrieve data to be provided to the client from an index corresponding to the period information.

According to another aspect of the present disclosure, there is provided a method for providing data based on cloud services, the method including: in response to an attribute of data, which is generated from a target object, being changed, updating, by a profile processor, updating a data profile that was previously stored; collecting, by a data collector, the data generated from the target object in accordance with the updated data profile; indexing, by a data processor, the collected data; and providing, by a data provider, the indexed data to a client.

Here, the updating of the data file that was previously stored comprises: detecting the changed attribute or a time at which the attribute is changed, and updating the previously stored data profile in accordance with the changed attribute or the time at which the attribute is changed.

Also, before the collecting of the data generated from the target object, the method may further include: updating, by the profile processor, the previously stored data profile in response to connection information about a connection to the target object being changed.

Also, the connection information may include authentication information for the connection to the target object or location information of the data in the target object.

Also, the updating of the previously stored data profile when the connection information is changed may include detecting the changed connection information or a time at which the connection information is changed, and updating the previously stored data profile in accordance with the changed connection information or the time at which the connection information is changed.

Also, the collecting of the data may include being connected to the target object using the connection information included in the updated data profile, and collecting data corresponding to the attribute included in the updated data profile.

Also, after the updating of the previously stored data profile when the attribute of the data is changed, the method may further include managing, by the profile processor, an update history of the data profile using the attribute or a time at which the connection information is changed.

Also, the indexing includes newly indexing the collected data whenever the data profile is updated, and after the indexing, the method may further include managing an indexing history of the data.

Also, the providing of the indexed data may include receiving period information of data to be provided from the client, and retrieving data to be provided to the client from an index corresponding to the period information.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram illustrating a detailed configuration of a data providing apparatus according to an embodiment of the present disclosure;

FIG. 2 is a block diagram illustrating a detailed configuration of a profile processor according to an embodiment of the present disclosure;

FIG. 3 is a block diagram illustrating a detailed configuration of a data processor according to an embodiment of the present disclosure;

FIG. 4 is a diagram illustrating an indexing history of data according to an embodiment of the present disclosure;

FIG. 5 is a block diagram illustrating a computing environment including a computing device suitable for being used in exemplary embodiments; and

FIG. 6 is a flowchart illustrating a data providing method according to an embodiment of the present disclosure.

### DETAILED DESCRIPTION OF EXEMPLARY EMBODIMENTS

Hereinafter, specific embodiments of the present disclosure will be described in detail with reference to the accompanying drawings. The following detailed description is provided to provide a comprehensive understanding of methods, apparatus, and/or systems described herein. However, this is merely an example and the present disclosure is not limited thereto.

When it is determined that a detailed description of a known art related to the present disclosure may unnecessarily obscure the gist of the present disclosure while describing the present disclosure, the detailed description thereof will be omitted. Further, the terminology described below is defined in consideration of functions in the present disclosure and may vary in accordance with a user's or operator's intention or usual practice. Thus, the meanings of the terminology should be interpreted based on the overall context of the present specification.

The terms used in this application are merely used for describing particular embodiments and are not intended to limit the present disclosure. A singular expression includes a plural expression unless clearly indicated otherwise in context. In this application, the terms “include” or “have” are for designating that features, numbers, steps, operations, elements, parts described in this specification or combinations thereof exist and are not to be construed as excluding the presence or possibility of adding one or more other features, numbers, steps, operations, elements, parts, or combinations thereof.

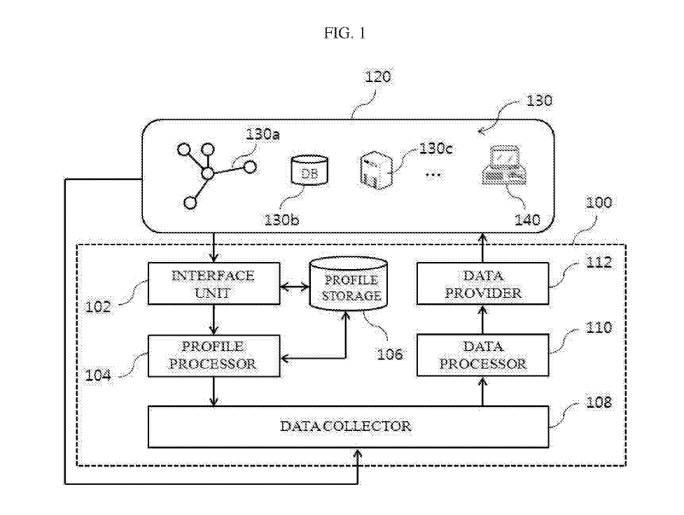

FIG. 1 is a block diagram illustrating a detailed configuration of a data providing apparatus 100 according to an embodiment of the present disclosure. The data providing apparatus 100 according to an embodiment of the present disclosure is an apparatus for providing data based on cloud services, and may be implemented on a SaaS (software as a service) platform. The SaaS platform refers to a cloud computing-based software distribution environment that enables a user to distribute necessary software or software functions in the form of services so that the distributed software or software functions can be used. In the present embodiment, the data providing apparatus 100 is connected to a target object 130 of a tenant 120 to collect data generated from the target object 130, refine the collected data, and then provide the refined data to a client 140. Here, the tenant 120 is an organization made up of a plurality of users, for example, a corporation, a company, or an enterprise. The data providing apparatus 100 may provide a data service in accordance with a request or actual situation of each tenant 120 to one or more tenants 120. In addition, in the present embodiment, the target object 130 is used in a broad sense including a device, a system, an application, a network, and the like which are data collection targets. For example, the target object 130 may be a sensor network 130a, a database 130b, a server 130c, or the like. However, the type of the target object 130 is not limited thereto, and various objects such as an application, a system network, a storage, a virtual machine instance provided by a cloud system (not shown), and the like may correspond to the target object 130 according to the present embodiment. In addition, the client 140 is a terminal that receives a data service from the data providing apparatus 100, and may be a terminal that is possessed by, for example, a manager of the tenant 120, a developer of the target object 130, a developer of a service provided by the tenant 120, or the like. Hereinafter, the detailed configuration of the data providing apparatus 100 will be described in detail with reference to FIG. 1.

As illustrated in FIG. 1, the data providing apparatus 100 according to an embodiment of the present disclosure includes an interface unit 102, a profile processor 104, a profile storage 106, a data collector 108, a data processor 110, and a data provider 112.

The interface unit 102 is a module that is used for accessing data generated from the target object 130 or receiving the data. The profile processor 104 may access the data generated from the target object 130 through the interface unit 102 or receive the data. In the present embodiment, the data generated in the target object 130 may be, for example, log data of the sensor network 130a, packet transmission/reception log data, transaction log data of the database 130b, file request log data, booting log data of the server 130c, kernel log data, application log data, or the like.

The profile processor 104 may monitor the data generated in the target object 130 through the interface unit 102, and detect, when an event in which an attribute of the data is changed occurs, the occurrence of the event. In the present embodiment, the attribute of the data is an element or a characteristic representing corresponding data, and may include, for example, a data length, a data type, a file name, a type of information included in the data (e.g., a user gender, a user location, a menu click log of a user, etc.), and the like. The profile processor 104 may detect the occurrence of the event by monitoring the data generated in the target object 130 through the interface unit 102 in real time. As an example, the profile processor 104 may detect the occurrence of the event (i.e., a change in the attribute of the data) by comparing a pattern of data stored in advance with a pattern of the monitored data. As another example, the target object 130 may call the event to the profile processor 104 when the attribute of the data is changed, and the profile processor 104 may detect the occurrence of the event by receiving the call. However, a method of detecting the event by the profile processor 104 is not limited to the above-described embodiments, and the profile processor 104 may detect the change in the attribute of the data using various methods.

In addition, the profile processor 104 may detect an occurrence time of the event when the event occurs, that is, a time at which the attribute of the data is changed. The occurrence time of the event can be used to manage an update history of a data profile to be described later.

The profile processor 104 may update a data profile previously stored in the profile storage 106 when the attribute of the data generated in the target object 130 is changed. Specifically, the profile processor 104 may detect the changed attribute or the time at which the attribute is changed, and update the data profile previously stored in the profile storage 106 according to the changed attribute of the data or the time at which the attribute is changed. In the present embodiments, the data profile is a set of information necessary for collecting and refining data, and may include, for example, an attribute of data to be collected, a data collection method, an indexing method, and the like. When the attribute of the data is changed, an attribute of data included in the data profile, a data collection method, and an indexing method should be also changed. Accordingly, the profile processor 104 may update the data profile stored in the profile storage 106 using the attribute that is changed based on the time at which the attribute of the data is changed. As will be described later, the data collector 108 may collect the data generated in the target object 130 according to the updated data profile.

In addition, the profile processor 104 may update the data profile previously stored in the profile storage 106 when connection information on connection to the target object 130 is changed. To this end, the profile processor 104 may detect not only the change in the attribute of the data but also a change in the connection information of the data. The target object 130 may be, for example, a virtual machine instance of a cloud system, and the data collector 108 should be able to be connected to (or access) the virtual machine instance so that the data collector 108 collects data generated in the virtual machine instance. The profile processor 104 may acquire the connection information of the data through the interface unit 102, and detect, when an event in which the connection information is changed occurs, the occurrence of the event. Here, the connection information may include, for example, authentication information (or authorization information) (e.g., a connection ID, a password, a key value, etc.) for a connection to the target object 130, location information of data in the target object 130 (e.g., an IP address of a place where data is stored in the target object 130, a connection URL (uniform resource locator) of data in the target object, identification information of an agent for streaming data in the target object 130, location information, etc.), and the like. When the event in which the connection information is changed occurs, the profile processor 104 may detect the changed connection information or a time at which the connection information is changed, and update the data profile stored in the profile storage 106 according to the changed connection information or the time at which the connection information is changed. As will be described later, the data collector 108 may be connected to the target object 130 using the connection information included in the updated data profile, and collect data corresponding to the attribute included in the updated data profile.

In addition, the profile processor 104 may manage the update history of the data profile using the time at which the attribute of the data is changed or the time at which the connection information of the data is changed. The profile processor 104 may update the data profile stored in the profile storage 106 in real time whenever the attribute of the data or the connection information of the data is changed. At this time, the profile processor 104 may record the time at which the attribute of the data is changed or the time at which the connection information of the data is changed, thereby managing the update history of the data profile. The update history of the data profile may be utilized as base data for retrieving the attribute of the data or the connection information of the data before and after the change in the data profile, or utilized as restoration data for restoring the attribute of the data or the connection information of the data before the change in the data profile.

The profile storage 106 is a place where the data profile is stored. As described above, the profile processor 104 may update the data profile stored in the profile storage 106 when the attribute of the data generated in the target object 130 or the connection information of the data is changed. The data profile stored in the profile storage 106 may be used while the data collector 108 collects the data generated in the target object 130.

The data collector 108 collects the data generated in the target object 130 according to the updated data profile. The data collector 108 may receive the updated data profile from the profile processor 104, and modify (or restart) a data collecting process based on the updated data profile. As an example, when the attribute included in the data profile is changed from “user gender/user location” to “user gender/user location/menu click log of user”, the data collector 108 may modify the data collecting process to collect data corresponding to the attribute “user gender/user location/menu click log of user”, and collect the data generated in the target object 130 according to the modified data collecting process. As another example, when the connection information included in the data profile is changed from “ID : 12345/Password : abcd/Data location : 111.111.111.11 (IP address)” to “ID : 12345/Password : abcd/Data location : 111.111.111.12 (IP address)”, the data collector 108 may modify the data collecting process so that it may be connected to the IP address “111.111.111.12” to collect data, and collect the data generated in the target object 130 according to the modified data collecting process.

That is, according to the embodiments of the present disclosure, when a collection condition such as an attribute of data, connection information of data, or the like is changed, the data collecting process may be dynamically changed to collect data according to the changed collection condition, and thus it is possible to collect data in accordance with the request or actual situation of each tenant 120.

The data processor 110 refines the data collected by the data collector 108 into a predetermined format. To this end, the data processor 110 may load the data collected by the data collector 108 and parse the loaded data. The data processor 110 may extract the attribute of the data by parsing the data. The data processor 110 may extract the attribute of the data by comparing, for example, a pattern of the collected data and a pattern of the stored data. Thereafter, the data processor 110 may index the data using the extracted attribute of the data. The data processor 110 may generate an index for the data using at least one of the extracted attributes of the data, and index the data in accordance with the generated index. The index is a means for facilitating data retrieval. The data processor 110 may generate the index using various indexing techniques such as a B−tree, a B+tree, an R−tree, and the like.

In addition, the data processor 110 may newly index the collected data whenever the data profile stored in the profile storage 106 is updated. As described above, when the collection condition such as the attribute of the data or the connection information is changed, the data collector 108 collects data according to the changed collection condition. In this case, the attribute of the collected data is changed, so that the data processor 110 may newly index the collected data. That is, according to the embodiments of the present disclosure, data retrieval conditions may be dynamically changed by newly indexing the collected data whenever the data profile is updated, and thus it is possible to retrieve data in accordance with the request or actual situation of each tenant.

In addition, the data processor 110 may manage an indexing history of data. The data processor 110 may record a time at which data is newly indexed whenever the data is newly indexed, thereby managing the indexing history of the data. As will be described later, the data provider 112 may receive period information of data to be provided from the client 140, and retrieve data to be provided to the client 140 from an index corresponding to the period information. As an example, assuming that data is newly indexed on each of dates of Mar 1, 2016/Apr 10, 2016/Jun 20, 2016 by the data processor 110, when the client 140 desires to receive data of a date of Apr 5, 2016, the data provider 112 may retrieve corresponding data from an index of the date of Mar 1, 2016. That is, according to the embodiments of the present disclosure, the past data may be easily retrieved with reference to the indexing history, and thus it is possible to provide a data service in accordance with a request or actual situation of each tenant 120.

The data provider 112 provides the data indexed by the data processor 110 to the client 140. The data provider 112 may provide the indexed data to the client 140, for example, in the form of SaaS. To this end, the data provider 112 may receive a data providing request from the client 140 and implement an API (application programming interface) that provides the indexed data according to the data providing request. The data provider 112 may provide the indexed data as cloud services via the API. In addition, the data provider 112 may provide a UI (user interface) for providing the indexed data, to the client 140. That is, the data provider 112 may provide data collected and retrieved according to the changed collection condition and the changed retrieval condition to the client 140 as an on-demand type service.

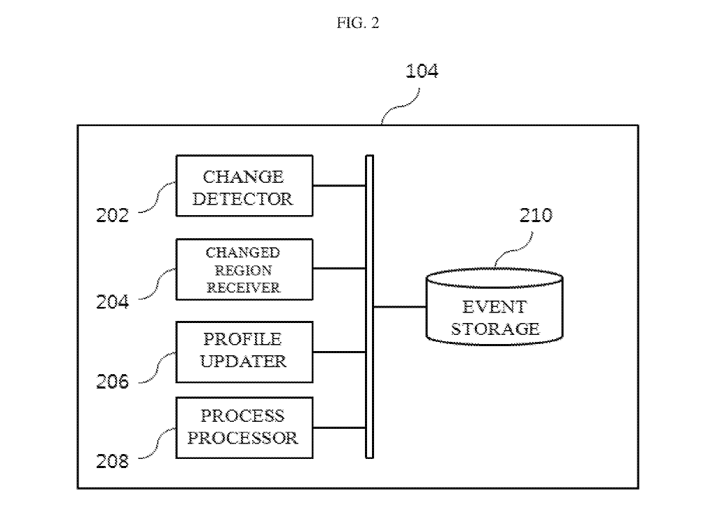

FIG. 2 is a block diagram illustrating a detailed configuration of the profile processor 104 according to an embodiment of the present disclosure. As illustrated in FIG. 2, the profile processor 104 includes a change detector 202, a changed region receiver 204, a profile updater 206, a process processor 208, and an event storage 210.

When an event in which an attribute of data generated in the target object 130 or connection information of the data is changed occurs, the change detector 202 detects the occurrence of the event. The change detector 202 may detect the occurrence of the event by, for example, comparing a pattern of previously stored data with a pattern of monitored data or receiving a call of the event from the target object 130.

In addition, the change detector 202 may store the event or an occurrence time of the event in the event storage 210 when the occurrence of the event is detected. The occurrence time of the event may be, for example, a time at which the attribute of the data is changed or a time at which the connection information of the data is changed.

The changed region receiver 204 receives a changed region of the data from the target object 130 through the interface unit 102. The changed region of the data may include, for example, the changed attribute of the data, the changed connection information of the data, and the like.

The profile updater 206 updates a data profile stored in the profile storage 106 using the changed region of the data received from the changed region receiver 204. As an example, when the attribute of the data is changed, the profile updater 206 may update the data profile stored in the profile storage 106 using the changed attribute of the data based on a time at which the attribute of the data is changed. As another example, when the connection information of the data is changed, the profile updater 206 may update the data profile stored in the profile storage 106 using the changed connection information of the data based on a time at which the connection information of the data is changed.

The process processor 208 modifies a data collecting process based on the updated data profile. As an example, when an attribute included in the data profile is changed, the process processor 208 may modify the data collecting process to collect data corresponding to the changed attribute, and collect data generated from the target object 130 according to the modified data collecting process. As another example, when connection information included in the data profile is changed, the process processor 208 may modify the data collecting process so that it may be connected to the target object 130 in accordance with the changed connection information to collect data, and collect data generated from the target object 130 according to the modified data collecting process.

The event storage 210 is a place where the event or the occurrence time of the event detected by the change detector 202 is stored. As described above, the change detector 202 may store the event or the occurrence time of the event in the event storage 210 when the occurrence of the event is detected.

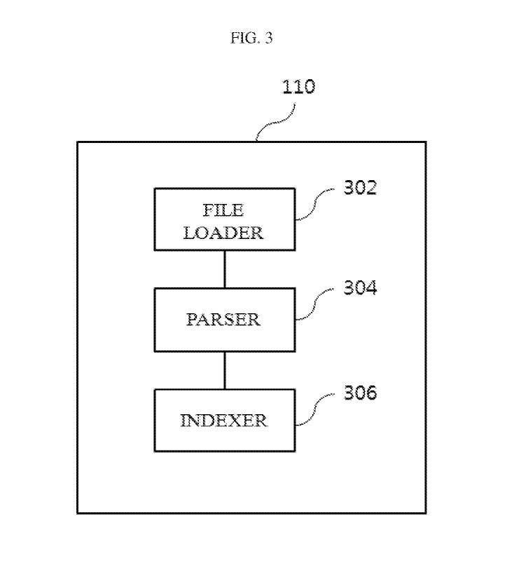

FIG. 3 is a block diagram illustrating a detailed configuration of a data processor according to an embodiment of the present disclosure. As illustrated in FIG. 3, the data processor 110 according to an embodiment of the present disclosure includes a file loader 302, a parser 304, and an indexer 306.

The file loader 302 loads data files collected by the data collector 108.

The parser 304 parses the data files and filters unnecessary data files. The parser 304 may extract attributes of the data files by parsing the data files. The parser 304 may extract the attributes of the data files by comparing, for example, a pattern of the collected data files and a pattern of stored data files.

The indexer 306 may index the data files using the extracted attributes of the data files. The indexer 306 may generate indexes for the data files using at least one of the extracted attributes of the data files, and index the data files in accordance with the indexes. The indexer 306 may generate the indexes using various indexing techniques, such as a B−tree, a B+-tree, an R−tree, and the like.

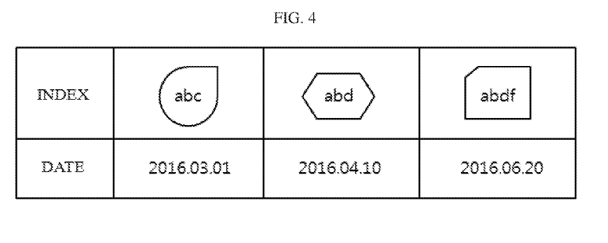

FIG. 4 is a diagram illustrating an indexing history of data according to an embodiment of the present disclosure. As described above, the data processor 110 may newly index collected data whenever the data profile is updated, and manage an indexing history of the data.

Referring to FIG. 4, when data is newly indexed by the data processor 110 on dates of Mar 1, 2016, Apr 10, 2016, and Jun 20, 2016, an index for the corresponding data may also be changed in accordance with the indexing history.

As an example, an index for a period from Mar 1, 2016 to Apr 9, 2016 may be abc, an index for a period from Apr 10, 2016 to Jun 19, 2016 may be abd, and an index for a period after Jun 20, 2016 may be abdf. As described above, the data provider 112 may easily retrieve past data with reference to the indexing history. For example, when the client 140 desires to receive data of Apr 5, 2016, the data provider 112 may retrieve the corresponding data from the index abc corresponding to a date of Apr 5, 2016.

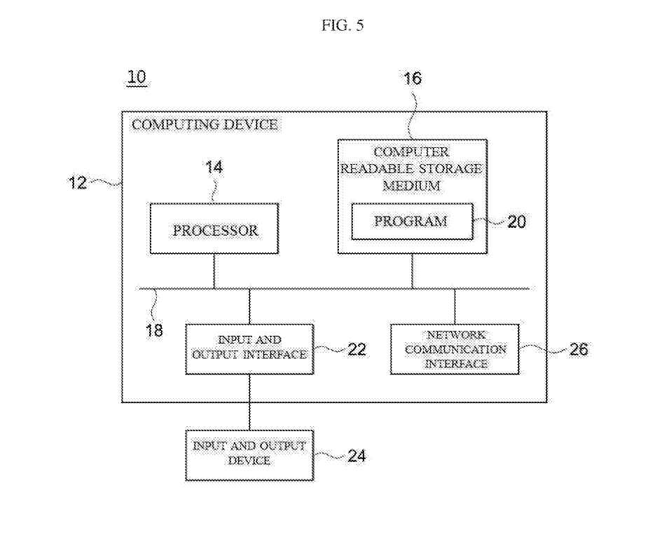

FIG. 5 is a block diagram illustrating a computing environment 10 including a computing device suitable for being used in exemplary embodiments. In the illustrated embodiments, respective components may have different functions and capabilities other than those described below, and additional components in addition to those described below may be provided.

The illustrated computing environment 10 includes a computing device 12. According to an embodiment, the computing device 12 may be a data providing apparatus 100, or one or more components included in the data providing apparatus 100.

The computing device 12 includes at least one processor 14, a computer-readable storage medium 16, and a communication bus 18. The processor 14 may cause the computing device 12 to operate in accordance with the exemplary embodiment discussed above. For example, the processor 14 may execute one or more programs stored on the computer-readable storage medium 16. The one or more programs may include one or more computer-executable instructions, and the computer-executable instructions may be configured to cause the computing device 12 to perform operations in accordance with the exemplary embodiment when the computer-executable instructions are executed by the processor 14.

The computer-readable storage medium 16 is configured to store computer-executable instructions or program codes, program data, and/or other suitable forms of information. A program 20 stored in the computer-readable storage medium 16 includes a set of instructions executable by the processor 14. In one embodiment, the computer-readable storage medium 16 may include a memory (a volatile memory such as a random access memory, a non-volatile memory, or any suitable combination thereof), one or more magnetic disk storage devices, optical disk storage devices, flash memory devices, or any other type of storage medium that can be accessed by the computing device 12 and store desired information, or any suitable combination thereof.

The communication bus 18 interconnects various other components of the computing device 12, including the processor 14 and the computer readable-storage medium 16.

The computing device 12 may also include one or more input/output (I/O) interfaces 22 that provide an interface for one or more input/output (I/O) device 24, and one or more network communication interfaces 26. The I/O interface 22 and the network communication interface 26 are connected to the communication bus 18. The I/O device 24 may be connected to other components of the computing device 12 via the I/O interface 22. The exemplary I/O device 24 may include a pointing device (such as a mouse or a trackpad), a keyboard, a touch input device (such as a touchpad or touch screen), a voice or sound input device, various types of sensor devices and/or an input device such as a photographing device, and/or an output device such as a display device, a printer, a speaker and/or a network card. The exemplary I/O device 24 may be included within the computing device 12 as a component of the computing device 12 and may be connected the computing device 12 as a separate device distinct from the computing device 12.

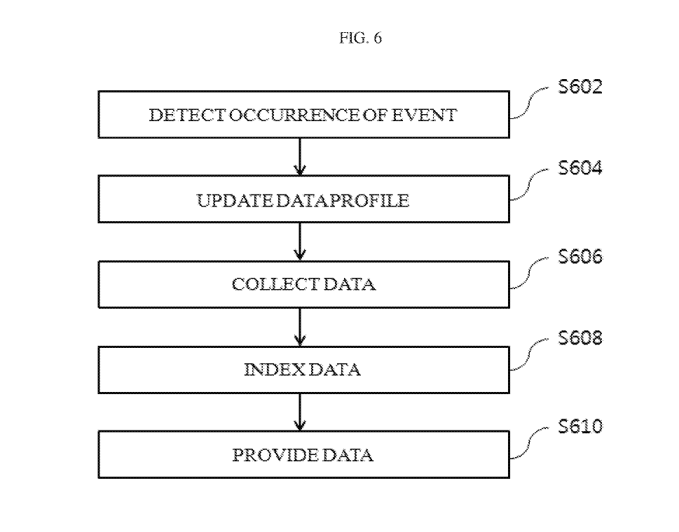

FIG. 6 is a flowchart illustrating a data providing method according to an embodiment of the present disclosure. While the flowchart illustrates that the method is performed in a plurality of operations, at least some operations may be performed in a different order, performed in combination with other operations, omitted, or performed in sub-operations, or performed with at least one operation that is not illustrated being added thereto.

In operation S602, the profile processor 104 may detect occurrence of an event. Specifically, when an attribute of data generated from the target object 130 is changed, the profile processor 104 may detect the changed attribute of the data or a time at which the attribute of the data is changed. In addition, when connection information of the data generated from the target object 130 is changed, the profile processor 104 may detect the changed connection information of the data or a time at which the connection information is changed.

In operation S604, the profile processor 104 may update a data profile stored in the profile storage 106 with reference to the event or a time at which the event occurs. Specifically, the profile processor 104 may update the data profile stored in the profile storage 106 in accordance with the changed attribute of the data or the time at which the attribute of the data is changed. In addition, the profile processor 104 may update the data profile stored in the profile storage 106 in accordance with the changed connection information of the data or the time at which the connection information of the data is changed.

In operation S606, the data collector 108 may collect the data generated from the target object 130 in accordance with the updated data profile. The data collector 108 may modify a data collecting process based on the updated data profile, and collect the data generated from the target object 130 in accordance with the modified data collecting process.

In operation S608, the data processor 110 may index the collected data. The data processor 110 may extract the attribute of the data by parsing the data collected by the data collector 108, and index the data using the extracted attribute of the data.

In operation S610, the data provider 112 may provide the indexed data to the client 140 in the form of SaaS. The data provider 112 may implement an API (application programming interface) that receives a data providing request from the client 140 and provides the indexed data in accordance with the request. The data provider 112 may provide the indexed data as cloud services via the API.

According to the embodiments of the present disclosure, when collection conditions such as an attribute of data, connection information of data, and the like are changed, the data collecting process may be dynamically changed to collect data in accordance with the changed collection conditions, and thus it is possible to collect data in accordance with a request or actual situation of each tenant.

In addition, according to the embodiments of the present disclosure, data retrieval conditions may be dynamically changed by newly indexing collected data whenever the data profile is updated, and thus it is possible to retrieve data in accordance with a request or actual situation of each tenant.

In addition, according to the embodiments of the present disclosure, the past data may be easily retrieved with reference to the indexing history, and thus it is possible to provide a data service in accordance with a request or actual situation of each tenant.

It will be apparent to those skilled in the art that various modifications can be made to the above-described exemplary embodiments of the present disclosure without departing from the spirit or scope of the disclosure. Thus, it is intended that the present disclosure covers all such modifications provided they come within the scope of the appended claims and their equivalents.

What is claimed is:

1. An apparatus for providing data based on cloud services, the apparatus comprising:
a profile processor configured to, in response to an attribute of data, which is generated from a target object, being changed, update a data profile that was previously stored;
a data collector configured to collect the data generated from the target object in accordance with the updated data profile;
a data processor configured to index the collected data; and
a data provider configured to provide the indexed data to a client.

2. The apparatus for providing data of claim 1, wherein the profile processor is further configured to detect the changed attribute or a time at which the attribute is changed, and update the previously stored data profile in accordance with the changed attribute or the time at which the attribute is changed.

3. The apparatus for providing data of claim 2, wherein the profile processor is further configured to update the previously stored data profile in response to connection information about a connection to the target object being changed.

4. The apparatus for providing data of claim 3, wherein the connection information includes authentication information for the connection to the target object or location information of the data in the target object.

5. The apparatus for providing data of claim 3, wherein the profile processor is further configured to detect the changed connection information or a time at which the connection information is changed, and update the previously stored data profile in accordance with the changed connection information or the time at which the connection information is changed.

6. The apparatus for providing data of claim 3, wherein the data collector is further configured to connect to the target object using the connection information included in the updated data profile, and collect data corresponding to the attribute included in the updated data profile.

7. The apparatus for providing data of claim 3, wherein the profile processor is further configured to manage an update history of the data profile using the attribute or a time at which the connection information is changed.

8. The apparatus for providing data of claim 7, wherein the data processor is further configured to newly index the collected data whenever the data profile is updated, and manage an indexing history of the data.

9. The apparatus for providing data of claim 8, wherein the data provider is further configured to receive period information of data to be provided from the client, and retrieve data to be provided to the client from an index corresponding to the period information.

10. A method for providing data based on cloud services, the method comprising:
in response to an attribute of data, which is generated from a target object, being changed, updating, by a profile processor, updating a data profile that was previously stored;
collecting, by a data collector, the data generated from the target object in accordance with the updated data profile;
indexing, by a data processor, the collected data; and
providing, by a data provider, the indexed data to a client.

11. The method for providing data of claim 10, wherein the updating of the data file that was previously stored comprises:
detecting the changed attribute or a time at which the attribute is changed, and updating the previously stored data profile in accordance with the changed attribute or the time at which the attribute is changed.

12. The method for providing data of claim 11, before the collecting of the data generated from the target object, further comprising:
updating, by the profile processor, the previously stored data profile in response to connection information about a connection to the target object being changed.

13. The method for providing data of claim 12, wherein the connection information includes authentication information for the connection to the target object or location information of the data in the target object.

14. The method for providing data of claim 12, wherein the updating of the previously stored data profile when the connection information is changed comprises:
detecting the changed connection information or a time at which the connection information is changed, and updating the previously stored data profile in accordance with the changed connection information or the time at which the connection information is changed.

15. The method for providing data of claim 12, wherein the collecting of the data comprises:
being connected to the target object using the connection information included in the updated data profile, and collecting data corresponding to the attribute included in the updated data profile.

16. The method for providing data of claim 12, wherein, after the updating of the previously stored data profile when the attribute of the data is changed, the method further comprises:
managing, by the profile processor, an update history of the data profile using the attribute or a time at which the connection information is changed.

17. The method for providing data of claim 16, wherein the indexing includes newly indexing the collected data whenever the data profile is updated, and
after the indexing, the method further comprises:
managing an indexing history of the data.

18. The method for providing data of claim 17, wherein the providing of the indexed data comprises:
receiving period information of data to be provided from the client, and retrieving data to be provided to the client from an index corresponding to the period information.
